(19) United States
(12) Patent Application Publication
(10) Pub. No.: US 2025/0307832 A1
(43) Pub. Date: Oct. 2, 2025

(54) METHOD FOR CUSTOMER CONSULTATION BY ARTIFICIAL INTELLIGENCE

(71) Applicant: INVENTIS CO., LTD., Seoul (KR)

(72) Inventor: Hoontack OH, Seongnam-si (KR)

(73) Assignee: INVENTIS CO., LTD., Seoul (KR)

(21) Appl. No.: 18/618,716

(22) Filed: Mar. 27, 2024

(51) Int. Cl. G06Q 30/015

(52) U.S. Cl. CPC G06Q 30/015

(57) ABSTRACT

A customer consultation method using artificial intelligence is disclosed. The customer consultation method according an embodiment of the disclosure may comprise: obtaining a real time consultation record between a customer and a counselor; analyzing the consultation record; displaying a request button for an answer generation of an artificial neural network on a counselor terminal screen when the analysis determines that the consultation record satisfies a predefined condition; inputting the consultation record to a first artificial neural network in response to the input of the request button from the counselor terminal, and generating a prompt corresponding to the consultation record based on an output of the first artificial neural network; and inputting the prompt to a second artificial neural network and generating a response to the prompt based on an output of the second artificial neural network. The consultation record may comprise an utterance of the customer and the counselor.

### TECHNICAL FIELD

Disclosed are a customer consultation method using artificial intelligence and a system to which the method is applied. More specifically, the present disclosure relates to a method for automatically generating artificial intelligence answers based on a consultation record between a counselor and a customer, and a computing system to which the method is applied.

### BACKGROUND

The method of using artificial intelligence chatbots has been widely adopted to minimize the labor cost for human counselors. The above-described method is a method for customers to send text queries to an AI which has been trained on the data of the domain the customers want to talk about, instead of having to speak with a counselor over the telephone. While having the advantage of reducing counselors' labor costs, the above-described method often provides unrelated answers to queries of customers due to the hallucination issue of an AI, which causes inconvenience to customers.

For the above reason, some customers prefer to speak with a human counselor over the phone, even though an AI chatting method offers the advantage of removing the waiting time and providing immediate answers to the part requiring consultation. However, due to reasons such as insufficient training of counselors and differences in product knowledge between designers and the counselors, some counselors may not be able to provide sufficient answers to the queries of customer.

Conventionally, when a counselor's knowledge of a product is insufficient, the workaround is to transfer the call of customer to a staff member involved in product design who has sufficient knowledge of the product, or to ask another counselor to respond to the difficult queries of the customer. The above workarounds would not only result in unnecessary manpower consumption, but also add to frustration of customer by requiring additional waiting time for customers who have been on hold for a long time for consultation.

In order to solve the above-described technical problem, there is a need for a non-manpower means to assist counselors who lack product knowledge, but such a method has not been provided in the related art.

### DETAILED DESCRIPTION

### Object

A technical problem to be achieved through some embodiments of the present disclosure is to provide a method for assisting consultation of a counselor who lacks knowledge of a product for customer consultation.

Another technical problem to be achieved through some embodiments of the present disclosure is to provide a method of receiving consultation content between a customer and a counselor in real time and generating a prompt for obtaining an answer of an AI corresponding to the real-time consultation content.

Another technical problem to be achieved through some embodiments of the present disclosure is to provide a method of providing a link capable of executing an application service corresponding to real-time consultation content between a customer and a counselor to the counselor who is consulting with the customer in real time.

Another technical problem to be achieved through some embodiments of the present disclosure is to provide a method of providing a link to a web page including information corresponding to real-time consultation content between a customer and a counselor to the counselor who is consulting with the customer in real time.

The technical problems of the present disclosure are not limited to the technical problems mentioned above, and other technical problems not mentioned would be clearly understood by those skilled in the art from the following description.

### Means

A customer consultation method using artificial intelligence according to one embodiment of the present disclosure to solve the above technical problems, comprises the steps of: obtaining a consultation record between a customer and a counselor in real time; analyzing the consultation record; and, when, as a result of the analysis, it is determined that the consultation record satisfies a predefined condition, displaying a request button for generating an artificial neural network answer on a screen of a terminal of the counselor; in response to receiving information on an input of the request button from the terminal of the counselor, inputting the consultation record to a first artificial neural network, and, based on an output of the first artificial neural network, generating a prompt corresponding to the consultation record; and inputting the prompt to a second artificial neural network and, based on an output of the second artificial neural network, generating an answer to the prompt, wherein the consultation record may comprise utterances of each of customer and the counselor.

In some embodiments, the predefined condition may be that a keyword existing in a database is included in the consultation record.

In some embodiments, the predefined condition may be that a trigger keyword is included in the consultation record. Here, the trigger keyword may be a keyword preset to display the request button when the trigger keyword is included in the consultation record.

In some embodiments, generating the answer to the prompt may comprise displaying a list of a plurality of answers to the generated prompt on a screen of the terminal of the counselor.

In some embodiments, generating the answer to the prompt may comprise displaying a button for transmitting the generated answer to the prompt to the terminal of the customer on the screen of the terminal of the counselor.

In some embodiments, the method may further comprise inputting an answer to the prompt into a third artificial neural network and providing additional information associated with the answer to the prompt to the terminal of the counselor based on an output of the third artificial neural network.

In some embodiments, the additional information associated with the answer to the prompt may comprise any one of an image and an identifier for any one of a plurality of landing pages which may be displayed on a screen of the terminal of the counselor associated with the prompt.

A customer consultation method using artificial intelligence according to another embodiment of the present disclosure for solving the above-described technical problem may comprise the steps of: obtaining a consultation record between a customer and a counselor in real time; receiving a request for generating an artificial neural network answer from a terminal of the counselor; inputting the consultation record to a first artificial neural network and generating one or more prompts corresponding to the consultation record based on an output of the first artificial neural network; inputting the prompt to a second artificial neural network and generating an answer to the prompt based on an output of the second artificial neural network; and inputting the answer to the prompt to a third artificial neural network and providing additional information associated with the answer to the prompt to the terminal of the counselor based on an output of the third artificial neural network. Wherein, the consultation record may comprise utterances of each of customer and the counselor.

In some embodiments, generating one or more prompts corresponding to the consultation record may comprise extracting a plurality of main keywords from the consultation record and generating the prompts based on the extracted main keywords.

In some embodiments, generating the one or more prompts corresponding to the consultation record may comprise, when there are a plurality of generated prompts, displaying a list of the plurality of generated prompts on a screen.

In some embodiments, generating the answer to the prompt may comprise displaying a list of a plurality of answers to the generated prompt on a screen.

In some embodiments, the method may be characterized to standardize the answer of the second artificial neural network before generating the answer to the prompt by inputting an instruction prompt to the second artificial neural network.

In some embodiments, the additional information associated with the answer to the prompt may comprise any one of an image and an identifier for any one of a plurality of landing pages which may be displayed on a screen of the terminal of the counselor associated with the prompt.

In some embodiments, receiving the request for generation of the answer of the artificial neural network from the counselor may comprise receiving a request for generation of the answer of the artificial neural network for the first utterance included in the consultation record from the counselor.

According to another embodiment of the present disclosure, there is provided a customer consultation method using artificial intelligence. The customer consultation method comprises the steps of: obtaining a consultation record between a customer and a counselor in real time; measuring a similarity between a keyword included in the consultation record and data in a database; inputting the consultation record to a first artificial neural network and generating one or more prompts corresponding to the consultation record based on an output of the first artificial neural network, when it is determined that the keyword included in the consultation record has a similarity greater than or equal to a reference value to the keyword in the data of the database; inputting the prompt to a second artificial neural network and generating an answer to the prompt based on an output of the second artificial neural network; and inputting the answer to the prompt to a third artificial neural network and providing additional information associated with the answer to the prompt based on an output of the third artificial neural network. Wherein, the consultation record may comprise utterances of each of customer and the counselor.

In some embodiments, the additional information associated with the answer to the prompt may comprise any one of an image and an identifier for any one of a plurality of landing pages which may be displayed on a screen of the terminal of the counselor associated with the prompt.

In some embodiments, generating the answer to the prompt may comprise displaying a button for transmitting the generated answer to the prompt to the terminal of the customer on a screen of the terminal of the counselor.

A computing system according to another embodiment of the present disclosure for solving the above-described technical problems may comprise one or more processors and a memory for storing a computer program executed by the one or more processors. The computer program may store instructions for performing operations of: obtaining a consultation record between a customer and a counselor in real time; analyzing the consultation record; displaying a request button for generation of an answer of an artificial neural network on a screen of a terminal of the counselor when it is determined that the consultation record satisfies a predefined condition as a result of the analysis; inputting the consultation record to a first artificial neural network in response to reception of information about the input of the request button from the terminal of the counselor, and generating a prompt corresponding to the consultation record based on an output of the first artificial neural network; and inputting the prompt to a second artificial neural network and generating an answer to the prompt based on an output of the second artificial neural network. Wherein, the consultation record may comprise utterances of each of customer and the counselor.

A computing system according to another embodiment of the present disclosure for solving the above-described technical problems may comprise one or more processors and a memory for storing a computer program executed by the one or more processors. The computer program may comprise instructions for: obtaining a consultation record between a customer and a counselor in real time; receiving a request for generation of an answer of an artificial neural network from a terminal of the counselor; inputting the consultation record to a first artificial neural network and generating one or more prompts corresponding to the consultation record based on an output of the first artificial neural network; inputting the prompt to a second artificial neural network and generating an answer to the prompt based on an output of the second artificial neural network; and inputting an answer to the prompt to a third artificial neural network and providing additional information associated with the answer to the prompt to the terminal of the counselor based on an output of the third artificial neural network. Wherein, the consultation record may comprise utterances of each of customer and the counselor.

A computing system according to another embodiment of the present disclosure for solving the above-described technical problems may comprise one or more processors and a memory for storing a computer program executed by the one or more processors. Here, the computer program may comprise instructions for performing the operations of: obtaining a consultation record between a customer and a counselor in real time; measuring similarity between a keyword comprised in the consultation record and data in a database; inputting the consultation record to a first artificial neural network and generating one or more prompts corresponding to the consultation record based on an output of the first artificial neural network, in response to a determination in which the keyword included in the consultation record has similarity greater than or equal to a reference value to a keyword present in the data in the database; inputting the prompt to a second artificial neural network and generating an answer to the prompt based on an output of the second artificial neural network; and inputting the response to the prompt to a third artificial neural network and providing additional information associated with the answer to the prompt based on an output of the third artificial neural network. Wherein, the consultation record may comprise utterances of each of customer and the counselor.

### BRIEF DESCRIPTION OF DRAWINGS

FIG. 1 illustrates an embodiment environment to which a computing system according to an embodiment of the present disclosure may be applied.

FIG. 2 is a flowchart of a customer consultation method using artificial intelligence according to another embodiment of the disclosure.

FIG. 3 is a diagram for describing a step of acquiring a consultation record in real time which may be performed in some embodiments of the present disclosure.

FIG. 4 is a flowchart for describing some steps described with reference to FIG. 2 in detail.

FIG. 5 is a diagram for describing a step of generating a prompt which may be performed in some embodiments of the present disclosure.

FIG. 6 is a diagram for describing a step of generating a prompt which may be performed in some other embodiments of the present disclosure.

FIG. 7 is a diagram for describing a step of inputting a prompt which may be performed in some embodiments of the present disclosure.

FIG. 8 is a diagram for describing a step of generating an answer to a prompt which may be performed in some embodiments of the present disclosure.

FIG. 9 is a diagram for describing a step of providing a link associated with an answer to a prompt which may be performed in some embodiments of the present disclosure.

FIG. 10 is a hardware diagram of a computing system according to an embodiment of the present disclosure.

### DESCRIPTION OF EMBODIMENTS

Hereinafter, embodiments of the present disclosure would be described in detail with reference to the accompanying drawings. The advantages and features of the present invention, and methods of achieving them, would become apparent upon reference to the embodiments described in detail with reference to the accompanying drawings. However, the technical idea of the present invention is not limited to the following embodiments, but may be implemented in various different forms, and the following embodiments are provided to complete the technical idea of the present invention and to fully inform those skilled in the art, to which the present invention pertains, of the scope of the present invention, and the technical idea of the present invention is only defined by the scope of the claims.

In describing the present disclosure, if it is determined that a detailed description of an associated known configuration or function may obscure the subject matter of the present invention, the detailed description thereof would be omitted.

Unless otherwise defined, terms (including technical and scientific terms) used in the following embodiments may be used in a sense commonly understood by those skilled in the art to which the present disclosure pertains but may vary according to the intention or precedent of a technician working in an associated field, the emergence of new technology, and the like. The terms used in the present disclosure are intended to describe embodiments and are not intended to limit the scope of the present disclosure.

The singular expression used in the following embodiments comprise a plurality of concepts unless the context clearly specifies that it is singular. In addition, the plural expression comprises a singular concept unless the context clearly specifies that it is plural.

In addition, the terms first, second, A, B, (a), (b), and the like used in the following embodiments are merely used to distinguish an element from another element, and the nature, sequence, or order of the element is not limited by the terms.

Prior to the description of various embodiments of the present disclosure, it is important to clarify the terminology used in the following embodiments.

In the following embodiments, a “landing page” may comprise a web page which may be displayed on a screen of a customer terminal or a counselor terminal, a page corresponding to a specific menu of an application, and the like. However, it should be noted that the “landing page” is not limited to any one of screens which could be displayed on the customer terminal or the counselor terminal.

Hereinafter, some embodiments of the present disclosure would be described with reference to the drawings.

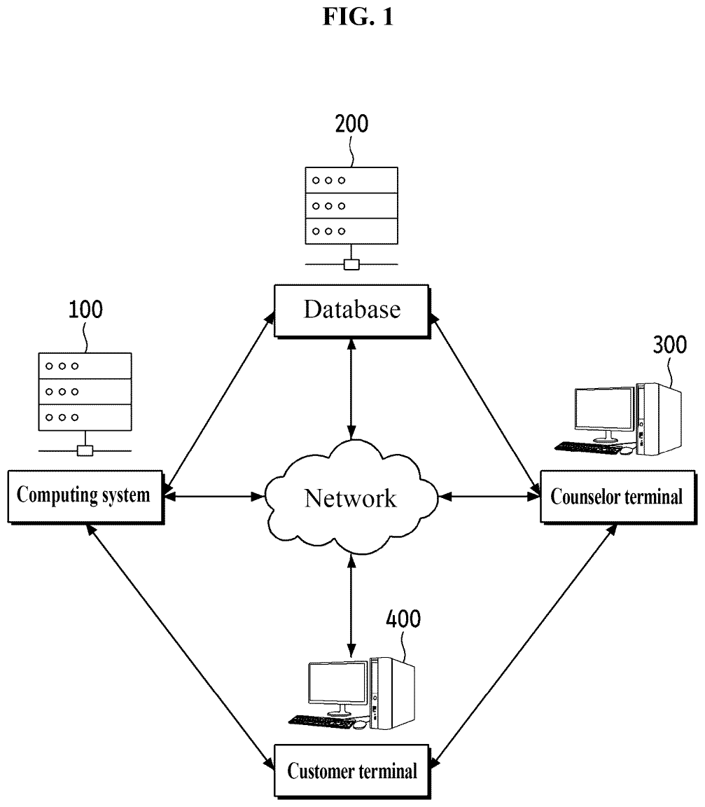

FIG. 1 illustrates an exemplary environment in which a computing system according to an embodiment of the present disclosure may be applied.

Each component illustrated in FIG. 1 may refer to software or hardware such as a field programmable gate array (FPGA) or an application-specific integrated circuit (ASIC). However, the components are not limited to software or hardware, and may be configured to be in an addressable storage medium or configured to execute one or more processors. The functions provided in the components may be implemented by more subdivided components, or may be implemented as one component which performs a specific function by combining a plurality of components.

In some embodiments, the computing system (100) may communicate with other components over a network. The network may be implemented as any type of wired/wireless network such as a Local Area Network (LAN), a Wide Area Network (WAN), a mobile radio communication network, and a Wireless Broadband Internet (Wibro).

The counselor terminal (300) and the customer terminal (400) may be a notebook, a desktop, a laptop, a smartphone, or a tablet, but are not limited thereto and may include all kinds of devices with computing function.

In an embodiment of the present disclosure, the computing system (100) may obtain a consultation record between a customer and a counselor in real time. Here, the consultation record may includes an utterance of each of the customer and the counselor.

In some embodiments of the present disclosure, the utterance of the customer may be received from the customer terminal (400), and the utterance of the counselor may be received from the counselor terminal (300).

In another embodiment of the present disclosure, the computing system (100) may analyze the obtained consultation record.

In another embodiment of the present disclosure, when it is determined that the consultation record satisfies a predefined condition as a result of analyzing the consultation record, the computing system (100) may display a request button for generation of an answer of an artificial neural network on the screen of the counselor terminal (300).

In some embodiments of the present disclosure, the predefined condition may include the fact that a keyword existing in the database (200) is included in the consultation record and a trigger keyword is included in the consultation record, which would be described in detail later.

In another embodiment of the present disclosure, in response to receiving information in which the counselor inputs a request button for generation of an answer of an artificial neural network displayed on the terminal of the counselor terminal (300), the computing system (100) may input the consultation record to the first artificial neural network, and generate a prompt corresponding to the consultation record based on an output of the first artificial neural network.

In some embodiments of the present disclosure, the prompt may be generated based on a main keyword included in the consultation record, but this would be described later.

In another embodiment of the present disclosure, the computing system (100) may input the generated prompt to the second artificial neural network and generate an answer to the prompt based on an output of the second artificial neural network.

In some embodiments of the present disclosure, the computing system (100) may transmit the generated answer to the prompt to the counselor terminal (300), and the counselor terminal (300) may display the answer to the prompt on the screen.

In some embodiments of the present disclosure, the counselor terminal (300) may display a button for transmitting the generated answer to the prompt to the customer terminal (400) on a screen.

In another embodiment of the present disclosure, the computing system (100) may input an answer to the prompt to the third artificial neural network, and based on an output of the third artificial neural network, may transmit additional information associated with the answer to the prompt to the counselor terminal (300).

In some embodiments of the present disclosure, the additional information associated with the answer to the prompt may include an identifier for any one of the pluralities of landing pages which may be displayed on the counselor terminal (300) associated with the answer to the prompt.

For embodiment, the counselor terminal (300) may display a first link for a first landing page corresponding to a first identifier on a screen when it is determined that the first identifier, which is additional information associated with the answer to the prompt, has been received from the computing system (100), and display the first landing page in response to an input of the counselor for the first link.

In some other embodiments of the present disclosure, the additional information associated with the answer to the prompt may include an image associated with the answer to the prompt.

Until now, the configuration and operation of the computing system (100) and the embodiment environment, to which the computing system (100) may be applied, have been described with reference to FIG. 1. It should be understood that the embodiments described above are exemplary in all aspects and are not limited thereto. In addition, the configuration and operation of the computing system (100) according to the present embodiment may be supplemented through some embodiments described below.

In some embodiments of the present disclosure, it would be understood that the computing system (100) and the database (200) operate according to a server-client model. However, in some embodiments, the system may be configured in a client stand-alone manner without the need for a server. In this case, it may be understood that the operation performed by the database (200) is performed in the computing system (100).

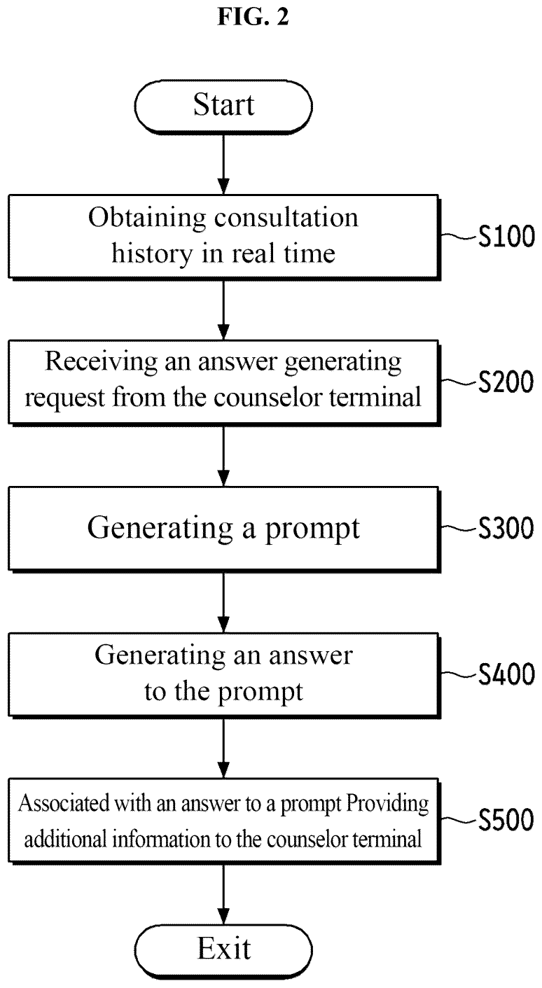

Hereinafter, a customer consultation method using artificial intelligence according to another embodiment of the present disclosure would be described with reference to FIGS. 2 to 9. Hereinafter, it may be understood that operations to be described in some flowcharts are performed by the computing system (100) described with reference to FIG. 1 unless otherwise specified. Further, the customer consultation method using artificial intelligence according to the present embodiment may obviously apply the technical idea which may be understood in the embodiment described above with reference to FIG. 1.

FIG. 2 is a flowchart of a customer consultation method using artificial intelligence according to another embodiment of the present disclosure.

At the step S100 shown in FIG. 2, the computing system (100) may obtain a consultation record between the customer and the counselor in real time.

In some embodiments associated with the step S100, the consultation record may be obtained as a result of STT (Speech to Text) processing of each of the utterance of the counselor received from the microphone of the counselor terminal (300) and the utterance of the customer received from the microphone of the customer terminal (400) by the computing system (100).

In some other exemplary embodiments associated with the step S100, the consultation record may be a text input to each of the counselor terminal (300) and the customer terminal (400) for the counselor and the customer to perform the chatting consultation.

In some other embodiments associated with the step S100, the computing system (100) may summarize the consultation record every unit time until the consultation is terminated. In addition, a title of consultation may be determined based on the result of the summary.

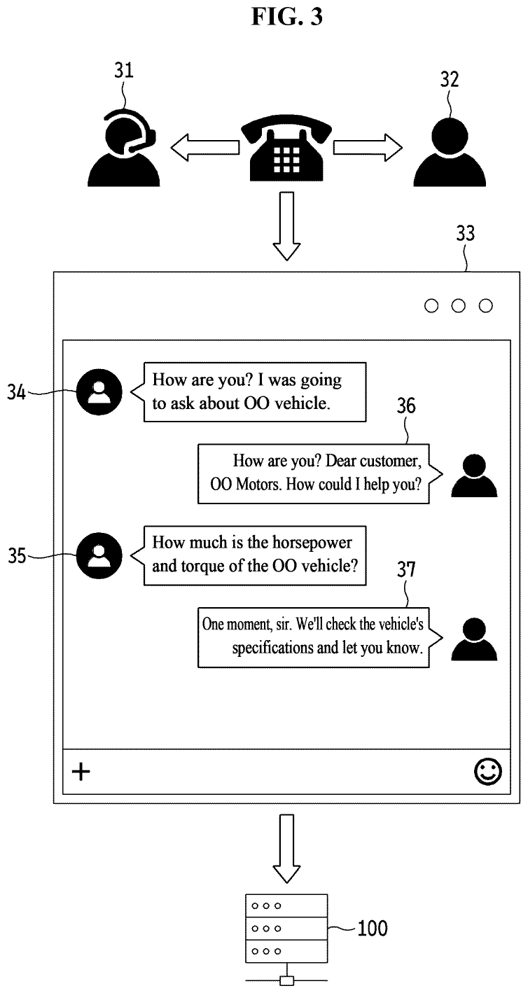

Hereinafter, in describing some exemplary embodiments of the present disclosure with reference to the drawings, it should be noted that the consultation between the counselor and the customer would be exemplified as the chatting consultation to help understanding of the present disclosure, but as shown in FIG. 3, the consultation between the counselor and the customer may be performed over the telephone.

In some other embodiments associated with the step S100, referring to FIG. 3, the computing system (100) may acquire each of the texts input to the first chatting session (33) by the counselor (31) and the customer (32) using each of the counselor terminal (300) and the customer terminal (400) in real time.

In some other embodiments associated with the step S100, referring to FIG. 3, the computing system (100) may determine the subject of the first chat session (33) as “OO vehicle consultation” at the time of receiving a first customer utterance (34) and a first counselor utterance (36), but may update the subject of the first chatting session (33) as “OO vehicle specification consultation” at the time of receiving a second customer utterance (35) and a second counselor utterance (37).

In the step S200 illustrated in FIG. 2, the computing system (100) may receive the request of the answer generation from the counselor terminal (300).

In the step S300, the computing system (100) may input the consultation record to the first artificial neural network in response to the received request of the answer generation, and generate a prompt corresponding to the consultation record based on an output of the first artificial neural network.

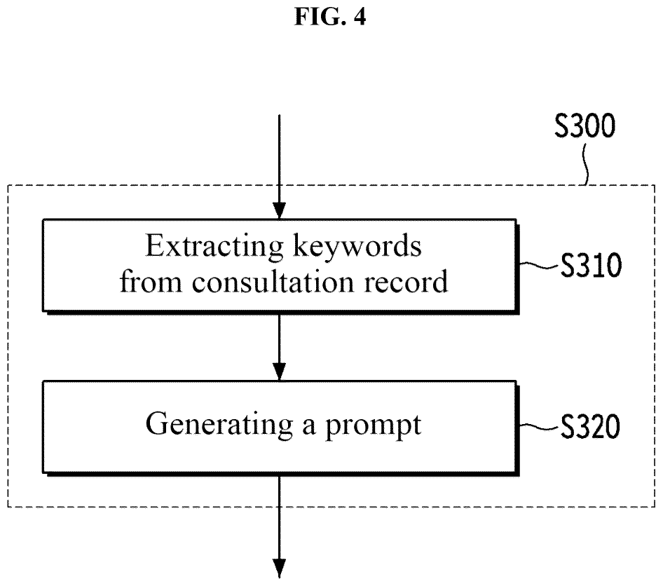

Some embodiments associated with the steps S200 and S300 may be clearly understood with reference to FIGS. 4 to 6 to be described later. Hereinafter, it would be described with reference to FIGS. 4 to 6.

At the step S310 shown in FIG. 4, the computing system (100) may extract a main keyword from the consultation record. Here, the method of extracting the main keyword by the computing system (100) is not limited to any one method if it is a method of extracting the main keyword from the conventional unstructured text.

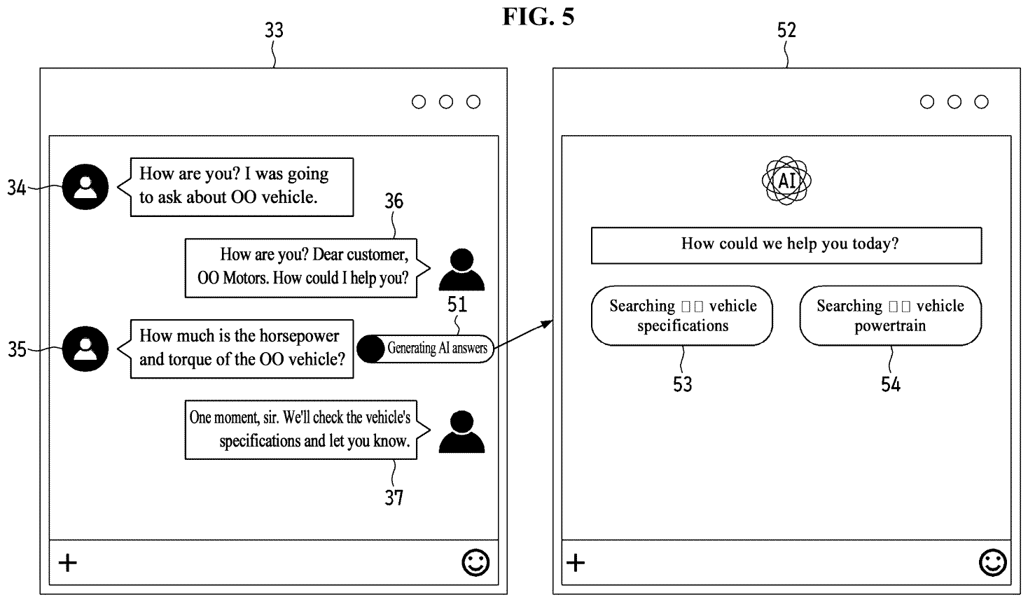

In some embodiments associated with the step S310, as shown in FIG. 5, the computing system (100) may extract “OO vehicle”, “horsepower”, “torque”, and “vehicle specification” as main keywords from the consultation record of the first chatting session (33).

In some embodiments associated with the step S200, when it is determined that the “00 vehicle” which is the main keyword of the second customer utterance (35) included in the consultation record of the first chatting session (33) exists in the database (200), the computing system (100) may request the counselor terminal (300) to display an AI answer generation button (51) on the interface of the first chatting session (33) displayed on the counselor terminal (300).

Subsequently, in response to receiving, from the counselor terminal (300), information in which the counselor inputs the AI answer generation button (51), in the step S320, the computing system (100) may input a consultation record of the first chatting session (33) to the first artificial neural network, generate a first prompt (53) and a second prompt (54), which are prompts corresponding to the consultation record of the first chatting session (33), based on an output of the first artificial neural network, and request to display, on a screen of the counselor terminal (300), the first AI chatting session (52) in which the first prompt (53) and the second prompt (54) are listed.

In some other embodiments associated with the step S200, when it is determined that the “OO vehicle” which is the main keyword of the second customer utterance (35) included in the consultation record of the first chatting session (33) exists in the database (200), the computing system (100) may request the counselor terminal (300) to display an AI answer generation button (51) to be adjacent to the second customer utterance (35) displayed on the interface of the first chatting session (33) displayed on the counselor terminal (300).

Subsequently, as information in which the counselor has input the AI answer generation button (51) is received from the counselor terminal (300), in the step S320, the computing system (100) may input the second customer utterance (35) to the first artificial neural network, generate a first prompt (53) and a second prompt (54), which are prompts corresponding to the second customer utterance (35), based on the output of the first artificial neural network, and request to display, on the screen of the counselor terminal (300), the first AI chatting session (52) in which the first prompt (53) and the second prompt (54) are listed.

According to this embodiment, the computing system (100) may allow the AI to output detailed information corresponding to a specific query of the customer by a counselor.

In some other embodiments associated with the step S200, when it is determined that the keyword “OO vehicle” which is one of the main keywords of the second customer utterance (35) included in the consultation record of the first chatting session (33) has a similarity equal to or greater than a reference value to data existing in the database (200), the computing system (100) may not perform an operation of displaying an AI answer generation button (51) on an interface of the first chatting session (33) displayed on the counselor terminal (300), and in the step S320, may input the consultation record of the first chatting session (33) into the first artificial neural network, generate a first prompt (53) and a second prompt (54) which are prompts corresponding to the consultation record of the first chatting session (33), and based on an output of the first artificial neural network, request the counselor terminal (300) to display the first AI chatting session (52), in which the first prompt (53) and the second prompt (54) are listed, on a screen of the counselor terminal (300).

According to the present embodiment, when there is any content which could be answered in the consultation record between the customer and the counselor, the computing system (100) may allow the AI to automatically output detailed information corresponding to the current consultation record.

In some other embodiments associated with the step S200, when it is determined that the trigger keyword (37-1), which is the ‘wait a moment’ keyword, exists in the second counselor utterance (37) included in the consultation record of the first chatting session (33), in the step S320, the computing system (100) may input the consultation record of the first chatting session (33) to the first artificial neural network, generate a first prompt (53) and a second prompt (54), which are prompts corresponding to the consultation record of the first chatting session (33), based on the output of the first artificial neural network, and request the counselor terminal (300) to display the first AI chatting session (52), in which the first prompt (53) and the second prompt (54) are listed, on the screen of the counselor terminal (300).

According to the present embodiment, the computing system (100) may identify that the counselor needs assistance in performing the consultation, and automatically provide the counselor with information corresponding to the current consultation record.

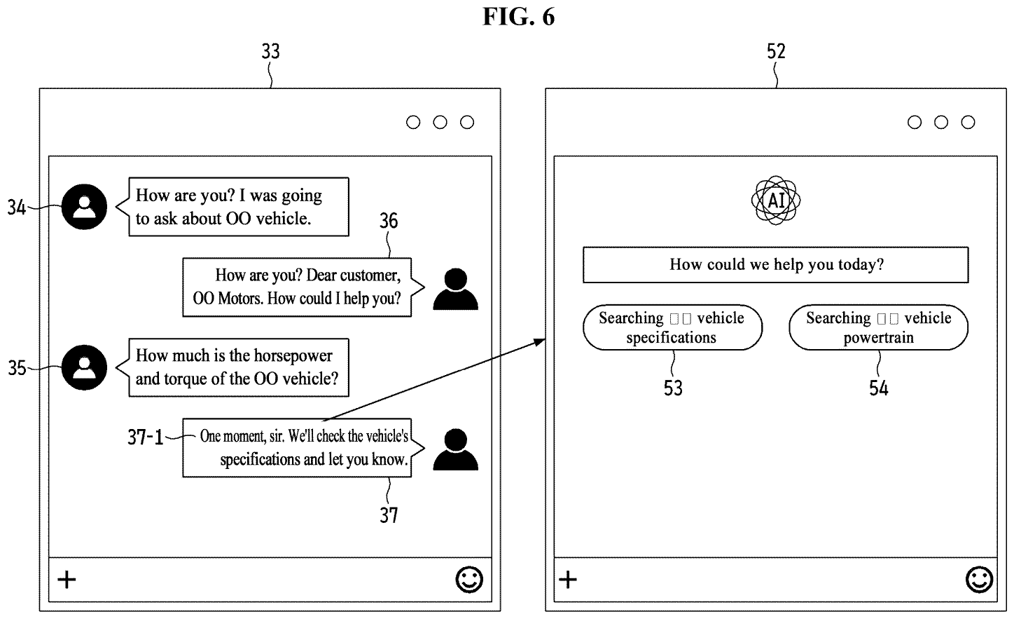

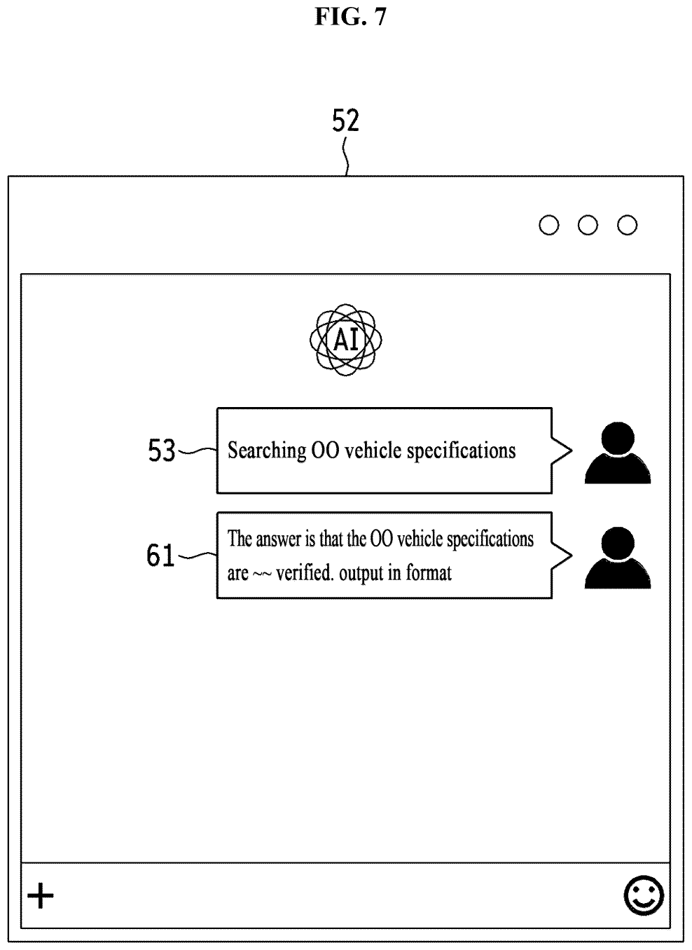

In some embodiments associated with the step S320, referring to FIGS. 6 and 7, when the counselor receives information indicating that the counselor received an input corresponding to the first prompt (53) displayed in the first AI chatting session (52) displayed on the screen of the counselor terminal (300) from the counselor terminal (300), the computing system (100) may input the first prompt (53) to the first AI chatting session (52) as shown in FIG. 7. Here, it may be understood that the first prompt (53) is input to the second artificial neural network.

Hereinafter, it would be described again with reference to FIG. 2.

In the step S400, the computing system (100) may input the prompt generated in the step S300 to the second artificial neural network, and generate an answer to the prompt based on an output of the second artificial neural network.

In some embodiments associated with the step S400, the second artificial neural network may be an artificial neural network trained based on data of a domain corresponding to a department of the counselor.

For example, as shown in FIG. 6, when the counselor is a counselor who performs a consultation on the vehicle, the second artificial neural network may be an artificial neural network which learns data on the vehicle.

In some other embodiments associated with the step S400, as shown in FIG. 7, the computing system (100) may input the first prompt (53) to the second artificial neural network via the first AI chatting session (52) and input the instruction prompt (61) to the second artificial neural network before the second artificial neural network outputs the answer. Although it is illustrated in FIG. 7 that the instruction prompt (61) is input after the first prompt (53) is input, in some other embodiments, the computing system (100) may input the instruction prompt (61) before inputting the first prompt (53) to the second artificial neural network.

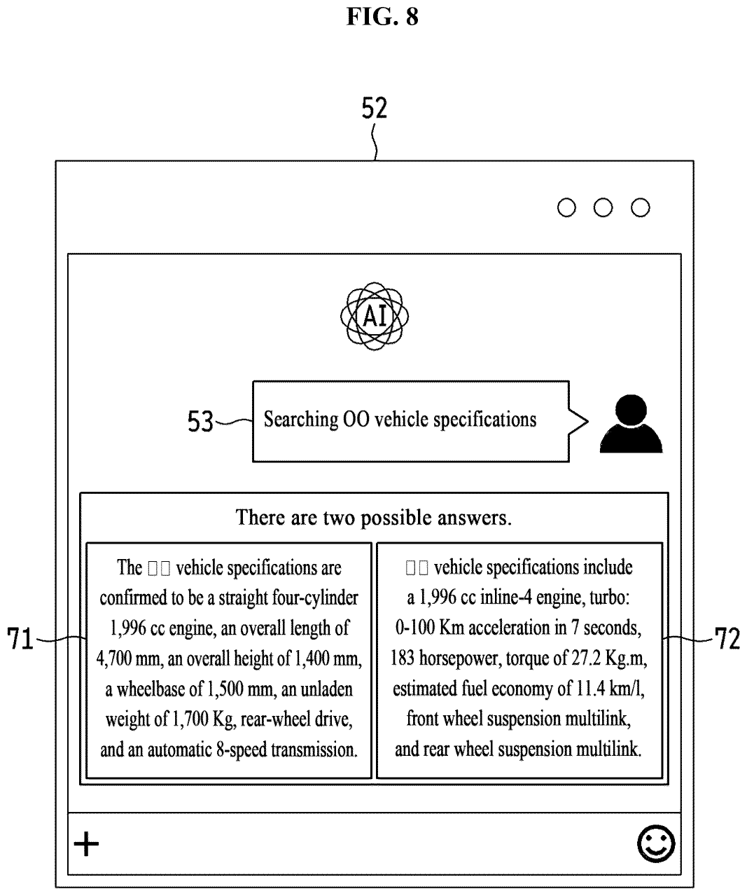

In some other embodiments associated with the step S400, referring to FIG. 8, as a result of inputting the first prompt (53) to the second artificial neural network, the computing system (100) may transmit the first answer (71) and the second answer (72) output by the second artificial neural network to the counselor terminal (300), and the counselor terminal (300) may list the first answer (71) and the second answer (72) on the screen.

According to the present embodiment, the computing system (100) may provide a plurality of answers to the counselor, thereby achieving the effect of reducing the possibility of hallucination answers of the second artificial neural network.

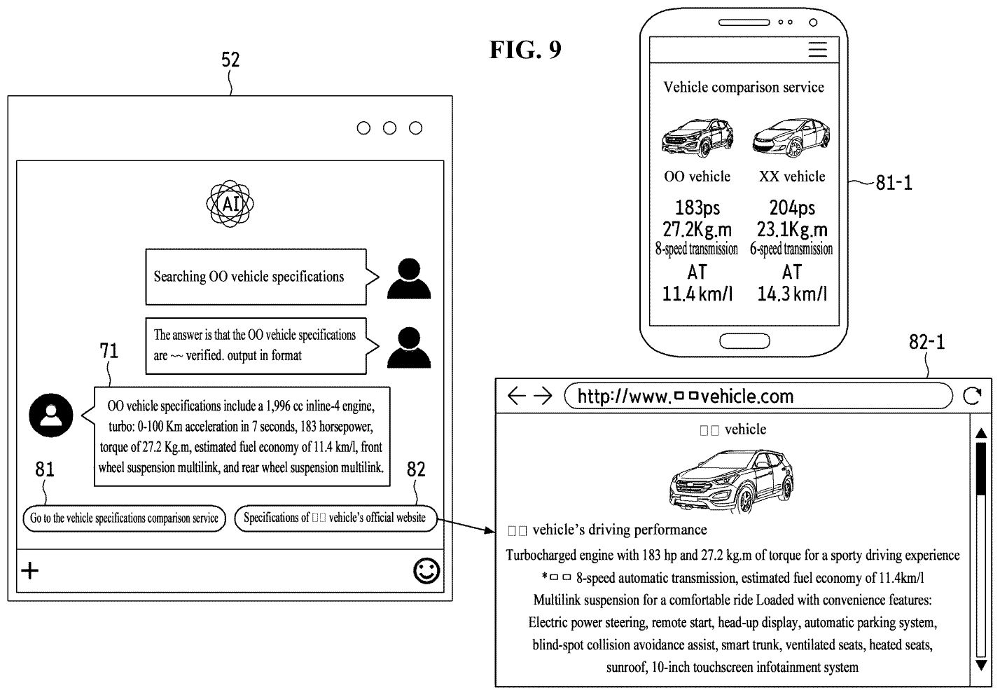

In some other embodiments associated with the step S400, referring to FIGS. 8 and 9, when it is determined that the counselor selected and input the second answer (72) in the first AI chatting session (52) displayed on the screen of the counselor terminal (300), the counselor terminal (300) may refresh the interface of the first AI chatting session (52) to indicate a form in which the AI outputs the second answer (71) as shown in FIG. 9.

In the step S500, the computing system (100) may transmit additional information associated with the answer to the prompt generated in the step S400 to the counselor terminal (300).

In some embodiments associated with the step S500, the computing system (100) may input the answer to the prompt generated in the step S400 to the third artificial neural network, and transmit additional information associated with the answer to the prompt to the counselor terminal (300) based on an output of the third artificial neural network.

In some other embodiments associated with the step S500, the additional information associated with the answer to the prompt may comprise an identifier for any one of a plurality of landing pages which may be displayed on the screen of the counselor terminal (300) associated with the prompt.

For example, referring to FIG. 9, the computing system (100) may input the second answer (71) selectively input by the counselor through the counselor terminal (300) to the third artificial neural network, and transmit the link of the vehicle comparison service (81-1) output by the third artificial neural network to the counselor terminal (300), and the counselor terminal (300) may refresh the interface of the first AI chatting session (52) to include a first button (81) corresponding to the link of the vehicle comparison service (81-1).

Here, the landing page of the vehicle comparison service (81-1) may be a landing page included in an application corresponding to the first AI chatting session (52), which is being executed by the counselor terminal (300).

In another example, referring to FIG. 9, the computing system (100) may input the second answer (71) selectively input by the counselor through the counselor terminal (300) to the third artificial neural network and transmit the link of the OO vehicle detailed information web page (82-1) output by the third artificial neural network to the counselor terminal (300), and the counselor terminal (300) may refresh the interface of the first AI chatting session (52) to include a second button (82) corresponding to the link of the OO vehicle detailed information web page (82-1).

In some other embodiments associated with the step S500, the additional information associated with the answer to the prompt may comprise an image or text associated with the prompt.

According to the present embodiment, when the counselor does not have specialized knowledge about the content queried by the customer and thus, smooth consultation is not possible, the counselor may be provided with information about the query of the customer.

Until now, the customer consultation method using artificial intelligence according to another embodiment of the present disclosure has been described with reference to FIGS. 2 to 9. It should be understood that the embodiments described above are exemplary in all aspects and are not limited thereto.

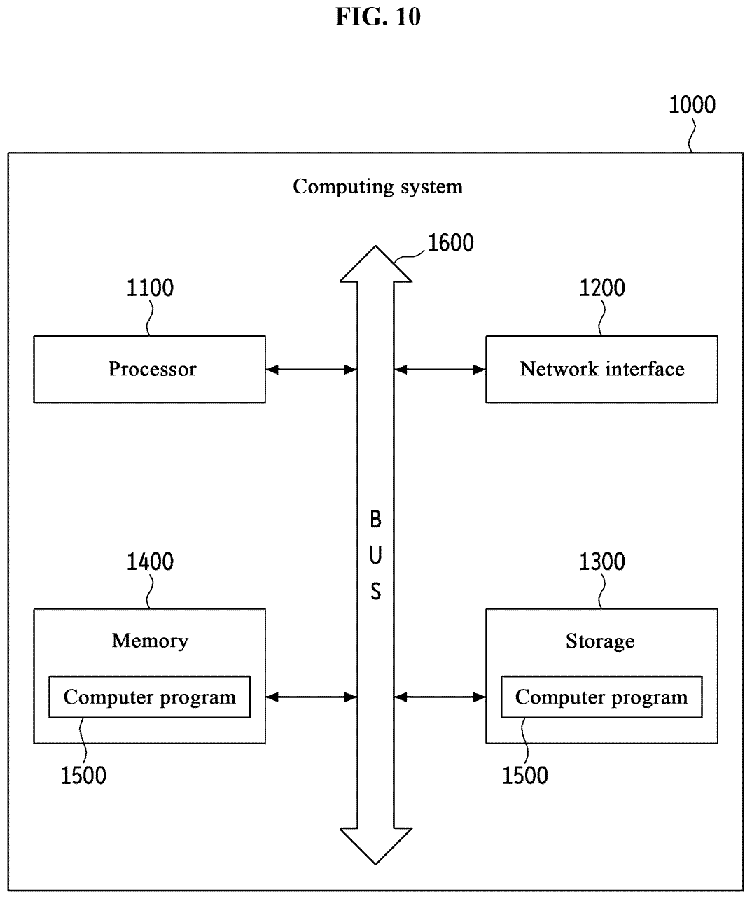

FIG. 10 is a hardware configuration diagram of a computing system (1000) according to some embodiments of the present disclosure. The computing system (1000) of FIG. 10 may be, for example, the computing system (100) described with reference to FIG. 1. As another example, the computing system (1000) of FIG. 10 may refer to the counselor terminal (300) described with reference to FIG. 1. The computing system (1000) may comprise one or more processors (1100), a system bus (1600), a communication interface (1200), a memory (1400) for loading a computer program (1500) executed by the processor (1100), and a storage (1300) for storing the computer program (1500).

The processor (1100) controls the overall operation of each component of the computing system (1000). The processor (1100) may perform an operation on at least one application or program for executing a method/operation according to various embodiments of the present disclosure. The memory (1400) stores various data, commands, and/or information. The memory (1400) may load one or more computer programs (1500) from the storage (1300) to execute methods/operations according to various embodiments of the present disclosure. The bus (1600) provides a communication function between the components of the computing system (1000). The communication interface (1200) supports Internet communication of the computing system (1000).

The storage (1300) may non-temporarily store one or more computer programs (1500). The computer program (1500) may comprise one or more instructions on which methods/operations according to various embodiments of the present disclosure are implemented. When the computer program (1500) is loaded on the memory (1400), the processor (1100) may perform methods/operations according to various embodiments of the present disclosure by executing the one or more instructions.

In some embodiments, the computing system (1000) described with reference to FIG. 10 may be configured by using one or more physical servers included in a server farm based on cloud technology such as a virtual machine. In this case, at least some of the processor (1100), the memory (1400), and the storage (1300) among the components shown in FIG. 10 may be virtual hardware, and the communication interface (1200) may also be configured as a virtualized networking component such as a virtual switch.

The computer program (1500) according to some exemplary embodiments of the present disclosure may comprise an instruction for allowing the computing system (1000) to: obtain a consultation record between a customer and a counselor in real time; analyze the consultation record; display a request button for generation of an answer of an artificial neural network on a screen of a counselor terminal if it is determined that the consultation record satisfies a predefined condition as a result of the analysis input the consultation record to a first artificial neural network in response to reception of information about input of the request button from the counselor terminal; generate a prompt corresponding to the consultation record based on output of the first artificial neural network; and input the prompt to a second artificial neural network and generate an answer to the prompt based on output of the second artificial neural network.

Until now, various embodiments of the present disclosure and effects according to the embodiments have been mentioned with reference to FIGS. 1 to 10. Effects according to the technical idea of the present disclosure are not limited to the effects mentioned above, and other effects not mentioned would be clearly understood by those skilled in the art from the following description.

The technical idea of the present disclosure described herein may be implemented as computer-readable code on a computer-readable medium. The computer program recorded in the computer-readable recording medium may be transmitted to another computing device through a network such as the Internet and installed in the other computing device, and thus may be used in the other computing device.

Although the operations are shown in a particular order in the drawings, it should not be understood that the operations must be executed in the particular order shown, or in sequential order, or that all illustrated operations must be executed in order to obtain the desired results. In certain situations, multitasking and parallel processing may be advantageous. Although embodiments of the disclosure have been described above with reference to the accompanying drawings, those skilled in the art, to which the disclosure pertains, may understand that the disclosure may be implemented in other specific forms without changing the technical idea or essential features. Therefore, it should be understood that the embodiments described above are exemplary in all aspects and are not limited thereto. The scope of protection of the present invention should be construed in accordance with the following claims, and all technical ideas within the scope thereof shall be construed to be included within the scope of technical idea rights as defined by this disclosure.

1. A customer consultation method using artificial intelligence performed by a computing system, comprising:
obtaining a consultation record between a customer and a counselor in real time wherein the consultation record includes an utterance of each of the customer and the counselor;
analyzing the consultation record;
displaying a request button for generation of an answer of an artificial neural network on a screen of the counselor terminal when it is determined that the consultation record satisfies a predefined condition as a result of the analysis;
inputting the consultation record to a first artificial neural network in response to receiving information about the input of the request button from the counselor terminal, and generating a prompt corresponding to the consultation record, based on an output of the first artificial neural network; and
inputting the prompt to a second artificial neural network and generating an answer to the prompt based on an output of the second artificial neural network.

2. The customer consultation method using artificial intelligence in the claim 1,
wherein the predefined condition includes
keyword present in a database in the consultation record.

3. The customer consultation method using artificial intelligence in the claim 1,
wherein the predefined condition includes
a trigger keyword is included in the consultation record wherein, when included in the consultation record, the trigger keyword is a keyword which is preset to display the request button.

4. The customer consultation method using artificial intelligence in the claim 1,
generating the answer to the prompt comprises
displaying a list of the generated answers to the prompt on a screen of the counselor terminal.

5. The customer consultation method using artificial intelligence in the claim 1,
generating the answer to the prompt comprises
includes displaying a button for transmitting the generated answer to the prompt to the customer terminal on the screen of the counselor terminal.

6. The customer consultation method using artificial intelligence in the claim 1,
further includes inputting the answer to the prompt to a third artificial neural network and providing additional information on the answer to the prompt to the counselor terminal, based on an output of the third artificial neural network.

7. According to the customer consultation method using artificial intelligence in the claim 6,
the additional information on the answer to the prompt comprises
any one of an identifier and an image for any one of a plurality of landing pages which may be displayed on the screen of the counselor terminal associated with the prompt.

8. A customer consultation method using artificial intelligence performed by a computing system, comprising:
obtaining a consultation record between a customer and a counselor in real time, wherein the consultation record comprises an utterance of each of the customer and the counselor;
receiving a request for generation of an answer of an artificial neural network from the counselor terminal;
inputting the consultation record to a first artificial neural network and generating one or more prompts corresponding to the consultation record based on an output of the first artificial neural network;
inputting the prompt to a second artificial neural network and generating the answer to the prompt based on an output of the second artificial neural network; and
inputting the answer to the prompt to a third artificial neural network and providing additional information on the answer to the prompt to the counselor terminal based on an output of the third artificial neural network.

9. According to the customer consultation method using artificial intelligence in the claim 8,
generating one or more prompts corresponding to the consultation record comprises the steps of: extracting a plurality of main keywords from the consultation record; and
generating the prompt based on the extracted main keyword.

10. According to the customer consultation method using artificial intelligence in the claim 8,
generating one or more prompts corresponding to the consultation record comprises:
displaying a list of the plurality of generated prompts displayed on a screen, when the generated prompts are plural.

11. According to the customer consultation method using artificial intelligence in the claim 8,
generating the answer to the prompt comprises
displaying on a screen a list of a plurality of answers to the generated prompt.

12. According to the customer consultation method using artificial intelligence in the claim 8,
before generating the answer to the prompt,
characterized by standardizing the answer from the second artificial neural network, by inputting an instruction prompt to the second artificial neural network.

13. According to the customer consultation method using artificial intelligence in the claim 8,
the additional information on the answer to the prompt comprises
any one of an identifier and an image for any one of a plurality of landing pages which may be displayed on the screen of the counselor terminal associated with the prompt.

14. According to the customer consultation method using artificial intelligence in the claim 8,
receiving the request for generation of an answer of an artificial neural network from the counselor comprises:
receiving a request for generation of an answer of an artificial neural network for the first utterance included in the consultation record from the counselor.

15. A customer consultation method using artificial intelligence performed by a computing system, comprising:
obtaining a consultation record between a customer and a counselor in real time, wherein the consultation record comprises an utterance of each of the customer and the counselor;
measuring similarity between a keyword included in the consultation record and data of a database;
inputting the consultation record to a first artificial neural network, when it is determined that a keyword included in the consultation record has a similarity greater than or equal to a reference value to keywords present in data of the database, and generating one or more prompt corresponding to the consultation record based on an output of the first artificial neural network;
inputting the prompt to a second artificial neural network and generating an answer to the prompt based on an output of the second artificial neural network; and
inputting an answer to the prompt to a third artificial neural network and providing additional information on the answer to the prompt based on an output of the third artificial neural network.

16. According to the customer consultation method using artificial intelligence in the claim 15,
the additional information on the answer to the prompt comprises
any one of an identifier and an image for any one of a plurality of landing pages which may be displayed on the screen of the counselor terminal associated with the prompt.

17. According to the customer consultation method using artificial intelligence in the claim 15,
generating the answer to the prompt comprises
includes displaying a button for transmitting the generated answer to the prompt to the customer terminal on the screen of the counselor terminal.

18. A computing system comprises:
one or more processors; and a memory which stores a computer program executed by the one or more processors.
The computer program comprises instructions for performing:
an operation of obtaining a consultation record between a customer and a counselor in real time, wherein the consultation record includes utterances of each of the customer and the counselor;
an operation of analyzing the consultation record;
an operation of displaying a request button for generation of an answer of an artificial neural network on the screen of the counselor terminal, when it is determined that the consultation record satisfies the predefined condition as a result of the analysis;
an operation of inputting the consultation record to a first artificial neural network in response to receiving information about the input of the request button from the counselor terminal, and generating a prompt corresponding to the consultation record based on an output of the first artificial neural network; and
an operation of inputting the prompt to a second artificial neural network and generating an answer to the prompt based on an output of the second artificial neural network.

19. A computing system comprises:
a memory which stores a computer program executed by the one or more processors,
The computer program comprises instructions for performing:
an operation of obtaining a consultation record between a customer and a counselor in real time, wherein the consultation record includes utterances of each of the customer and the counselor;
includes instructions for performing: an operation of receiving a request for generation of an answer of an artificial neural network from a counselor terminal;
an operation of inputting the consultation record to a first artificial neural network, and generating one or more prompts corresponding to the consultation record based on an output of the first artificial neural network;
an operation of inputting the prompt to a second artificial neural network and generating an answer to the prompt based on an output of the second artificial neural network; and
an operation of inputting the answer to the prompt to a third artificial neural network and providing additional information on the answer to the prompt to the terminal of the counselor based on an output of the third artificial neural network.

20. A computing system comprises:
a memory which stores a computer program executed by the one or more processors,
The computer program comprises instructions for performing:
an operation of obtaining a consultation record between a customer and a counselor in real time, wherein the consultation record includes utterances of each of the customer and the counselor;
includes instructions for performing: an operation of measuring similarity between a keyword included in the consultation record and data of a database;
an operation of inputting the consultation record to a first artificial neural network when it is determined that a keyword included in the consultation record has a similarity greater than or equal to a reference value to keywords present in the data of the database, and generating one or more prompt corresponding to the consultation record based on an output of the first artificial neural network;
an operation of inputting the prompt to a second artificial neural network and generating an answer to the prompt based on an output of the second artificial neural network; and
an operation of inputting the answer to the prompt to a third artificial neural network, and providing additional information on the answer to the prompt based on an output of the third artificial neural network.
